(19) United States
(12) Patent Application Publication
(10) Pub. No.: US 2010/0078480 A1
(43) Pub. Date: Apr. 1, 2010

(54) METHOD OF POSITIONING THE BARCODE

(75) Inventor: Wynn L. AKER, Manorville, NY (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Schaumburg, IL (US)

(21) Appl. No.: 12/240,335

(22) Filed: Sep. 29, 2008

(51) Int. Cl. G06K 7/10; B65D 85/00

(52) U.S. Cl. 235/462.08; 206/459.5; 235/494

(57) ABSTRACT

A method of associating a barcode with a product that has a product body with a round ending section. The method includes positioning the barcode repetitively along a circle sharing a common center with an outer-ring of the round ending section. A method of reading such a barcode on such a product includes positioning at least a portion of the round ending section of the product within a field of view of a barcode reader such that a complete barcode can be construed from a portion of a first instance of the barcode and a portion of the second distance of the barcode.

### FIELD OF THE DISCLOSURE

The present disclosure relates generally to barcodes.

### BACKGROUND

Many beverage pods have generally cylindrical shapes and can be rotationally symmetric. Some times, these beverage pods are physically keyed to break the rotational symmetry so that these beverage pods can be placed in a brewer in only one orientation. FIG. 1A-FIG. 1B illustrate a keyed beverage pod 40 with a barcode 50 printed on the surface of a round ending section 45. The keyed beverage pod 40 is keyed with some physical extension 48 to break the generally rotational symmetry of the beverage pod. When a keyed beverage pod is placed in a multi-beverage brewer with a fixed orientation, a barcode reader in the multi-beverage brewer can repeatedly find the barcode and decode the information in the barcode to allow the multi-beverage brewer to handle the keyed beverage pod accordingly. Many beverage pods, however, are not keyed and it is still desirable for a barcode reader in a brewer to find the barcode on the beverage repeatedly and reliably.

Generally, if a product is somewhat cylindrically symmetric and has some of its information coded with barcodes, when such product is to be handled by certain handling-machine, it may be desirable for a barcode reader in the handling-machine to find the barcode on such product repeatedly and reliably.

### SUMMARY

In one aspect, the invention is directed to a product. The product includes a product body with a round ending section, and a barcode repetitively positioned along a circle sharing a common center with an outer-ring of the round ending section.

Implementations of the invention can include one or more of the following features. The product body can be cylindrically symmetric. The product body can have the shape of a cylinder, or the shape of a conic cylinder. The diameter of the circle can be substantially equal to or smaller than the diameter of the outer-ring of the round ending section. Two instances of the barcode can be separated by a gap, can be adjoining to each other, or can be overlapping with each other.

In another aspect, the invention is directed to a method of associating a barcode with a product that has a product body with a round ending section. The method includes positioning the barcode repetitively along a circle sharing a common center with an outer-ring of the round ending section of the product body.

Implementations of the invention can include one or more of the following advantages. A barcode reader can read the information coded in the barcode on a product regardless of the rotational orientation of the somewhat cylindrically symmetric product body.

These and other advantages of the present invention will become apparent to those skilled in the art upon a reading of the following specification of the invention and a study of the several figures of the drawings.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A-FIG. 1B illustrate a keyed beverage pod with a barcode printed on the surface of a round ending section.

FIG. 2A-FIG. 2B illustrate a product with a product body that is somewhat cylindrically symmetric and some information of the product is coded with barcodes in accordance with some embodiments.

FIG. 3A-FIG. 3C illustrate several different shapes of the product body that is somewhat cylindrically symmetric.

FIG. 4A-FIG. 4C, illustrate several different embodiments in which the barcode is repetitively positioned along a circle sharing a common center with an outer-ring of the round ending section of the product body.

FIG. 5A-FIG. 5B illustrate that a barcode reader can read the information coded in the barcode even if the orientation of the product body is not fixed, in accordance with some embodiments.

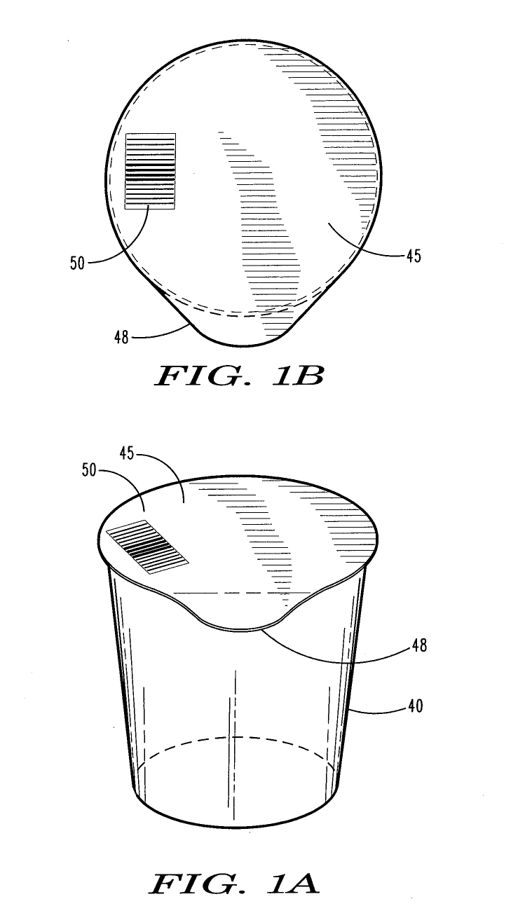

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

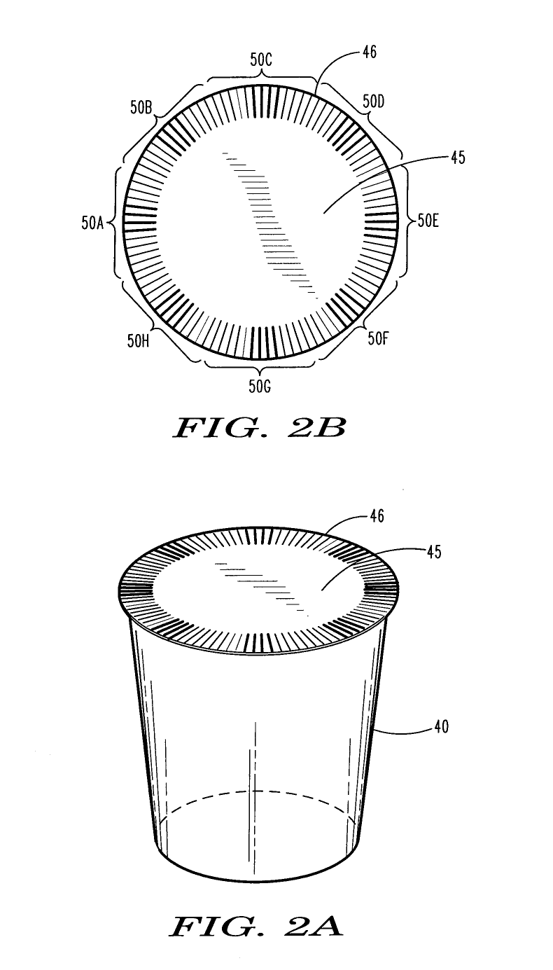

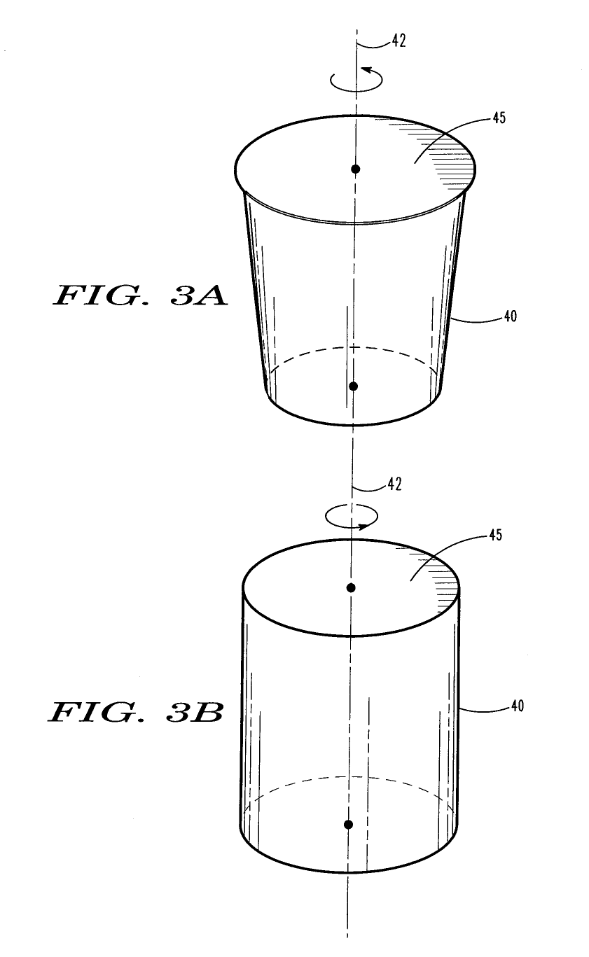

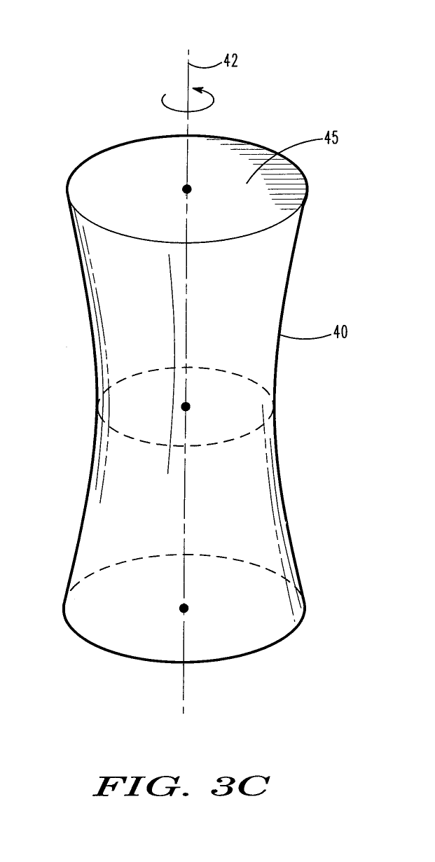

FIG. 2A-FIG. 2B illustrate a product with a product body 40 that is somewhat cylindrically symmetric and some information of the product is coded with barcodes in accordance with some embodiments. In FIG. 2A, the product body 40 is generally in the shape of a conic cylinder. The product body 40 is terminated with a round ending section 45. FIG. 2B is a top view of the product body 40. In FIG. 2B, a barcode is repetitively positioned along an out-ring 46 of the round ending section 45. Multiple instances of the same barcode, 50A-50H, are printed on the surface of the round ending section 45. In other implementations, the barcode can be repetitively positioned along a circle sharing a common center with an outer-ring of the round ending section, and the diameter of such circle can be smaller than the diameter of the outer-ring. In general, the product body 40 can be in the shape of a conic cylinder as shown in FIG. 3A, in the shape of a cylinder as shown in FIG. 3B, or in any other shape that is somewhat cylindrically symmetric as shown in FIG. 3C.

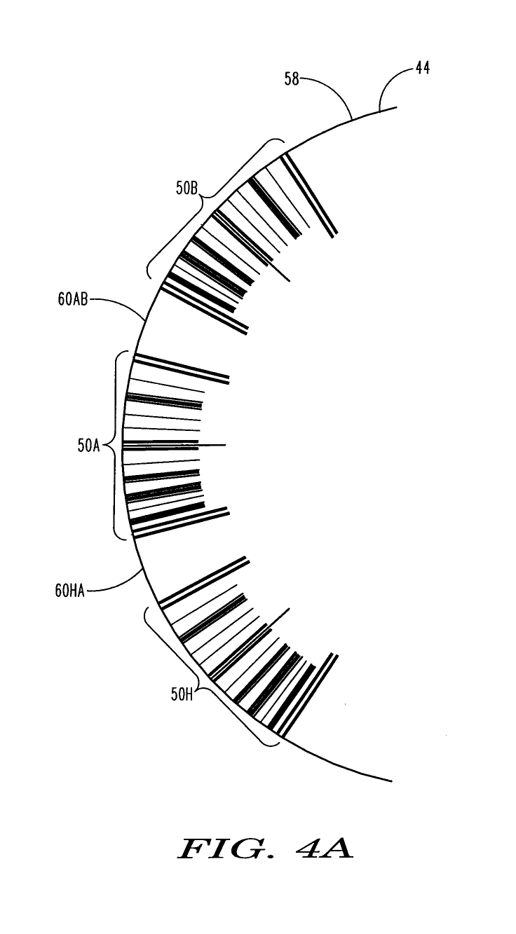

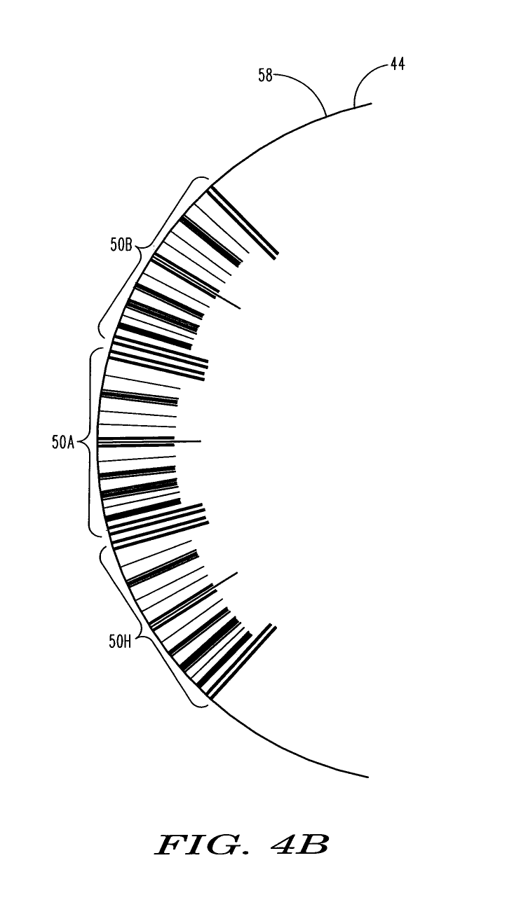

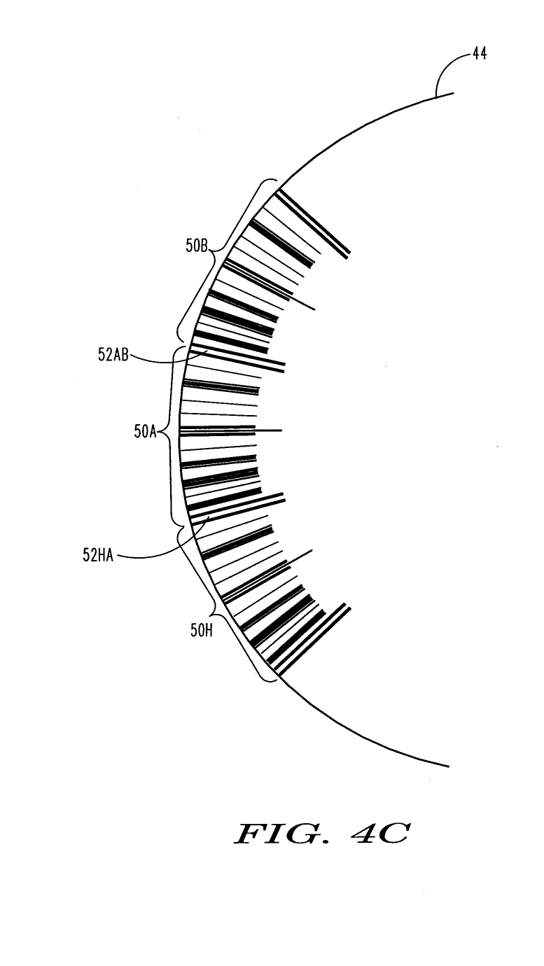

In one implementation, as shown in FIG. 4A, two instances of the barcode are separated by a gap. For example, instance 50A of the barcode is separated from instance 50B of the barcode with a gap 60AB, and instance 50A of the barcode is separated from instance 50H of the barcode with a gap 60HA.

In another implementation, as shown in FIG. 4B, two instances of the barcode are positioned adjoining to each other such that there is no gap between the two instances of the barcode. For example, instance 50A of the barcode is positioned adjoining to instance 50B of the barcode, and instance 50A of the barcode is also positioned adjoining to instance 50H of the barcode.

In another implementation, as shown in FIG. 4C, two instances of the barcode are overlapping each other such that the two instances of the barcode share at lest one common bar. For example, instance 50A of the barcode is overlapping with instance 50B of the barcode and the two instances share common bars 52AB, and instance 50A of the barcode is also overlapping with instance 50H of the barcode and the two instances share common bars 52HA. In one implementation, when the barcode is in the form of the Universal Product Code (UPC), two instances of the same UPC code can share the guard bars which normally are appended at each end of a UPC code.

In FIG. 4A-FIG. 4C, the barcode is repetitively positioned along a circle 44 sharing a common center with an outer-ring of the round ending section of the product body. The diameter of the circle 44 can be substantially equal to the diameter of the outer-ring 46 as shown in FIG. 2A-2B. The diameter of the circle 44 can be smaller than the diameter of the outer-ring 46.

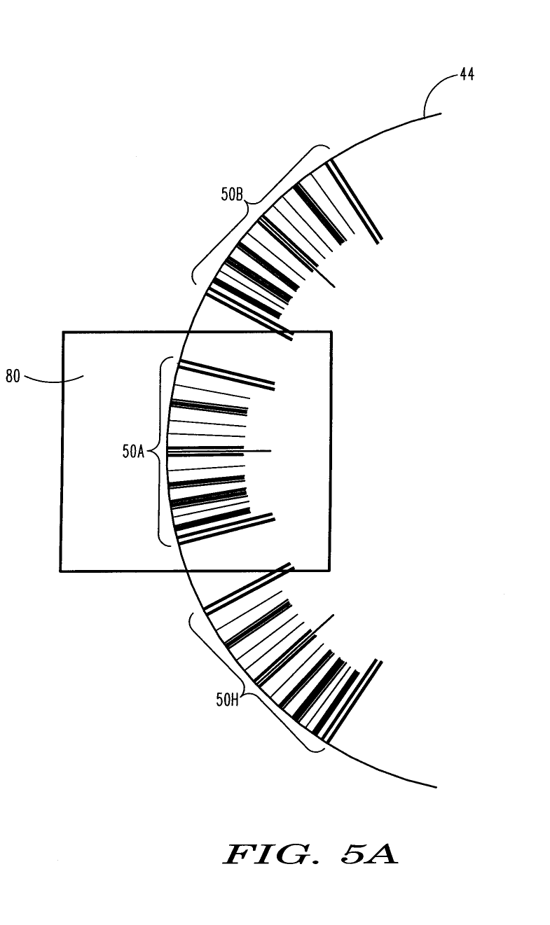

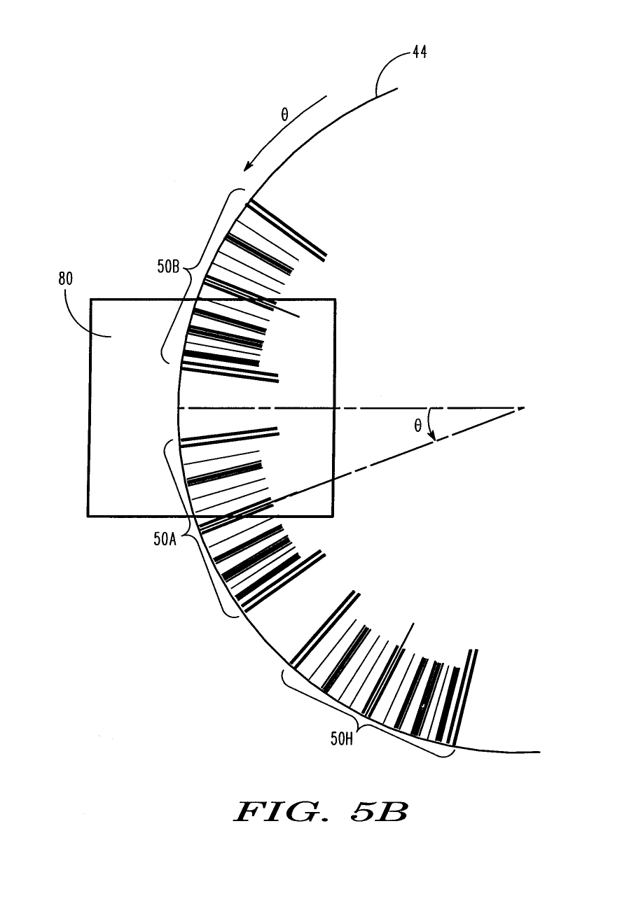

As shown in FIG. 5A-FIG. 5B, when a barcode is repetitively positioned along a circle 44, a barcode reader can read the information coded in the barcode even if the orientation of the product body is not fixed. In FIG. 5A, one instance 50A of the barcode is completely within the view 80 of the barcode reader, the barcode reader certainly can read and decode this instance of barcode. In FIG. 5B, the orientation of the product body is changed by an angle θ as compared with the orientation in FIG. 5A. Because of such orientation change, a portion of the instance 50A is moved out of the view 80 of the barcode reader, whereas a portion of another instance 50B is moved into the view 80 of the barcode reader. While neither the instance 50A nor the instance 50B can provide the complete information of the barcode independently, the combination of both the instance 50A and the instance 50B may possibly provide enough information to construe the barcode completely, provided that the view 80 of the barcode reader covers sufficient portion of the instance 50A and sufficient portion of the instance 50B. Consequently, a barcode reader can read the information coded in the barcode regardless of the rotational orientation of the somewhat cylindrically symmetric product body.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article or apparatus that comprises, has, includes, contains a list of elements does not include only those elements but may include other elements not expressly listed or inherent to such process, method, article or apparatus. An element proceeded by “comprises . . . a”, “has . . . a”, “includes . . . a”, “contains . . . a” does not, without more constraints, preclude the existence of additional identical elements in the process, method, article or apparatus that comprises, has, includes or contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A product comprising:
a product body with a round ending section; and
a barcode repetitively positioned along a circle sharing a common center with an outer-ring of the round ending section.

2. The product of claim 1, wherein the product body is cylindrically symmetric.

3. The product of claim 1, wherein the product body has the shape of a cylinder.

4. The product of claim 1, wherein the product body has the shape of a conic cylinder.

5. The product of claim 1, wherein the product body is a beverage pod container.

6. The product of claim 1, wherein the diameter of the circle is substantially equal to the diameter of the outer-ring of the round ending section.

7. The product of claim 1, wherein the diameter of the circle is smaller than the diameter of the outer-ring of the round ending section.

8. The product of claim 1, wherein two instances of the barcode are separated by a gap.

9. The product of claim 1, wherein two instances of the barcode are separated by a white gap having no coded bar therein.

10. The product of claim 1, wherein two instances of the barcode are separated by a black gap having no coded space therein.

11. The product of claim 1, wherein two instances of the barcode are adjoining each other such that there is no gap between the two instances of the barcode.

12. The product of claim 1, wherein two instances of the barcode are overlapping each other such that the two instances of the barcode share at lest one common bar.

13. The product of claim 1, wherein the barcode is repetitively printed along the circle.

14. A method of associating a barcode with a product that has a product body with a round ending section comprising:
positioning the barcode repetitively along a circle sharing a common center with an outer-ring of the round ending section of the product body.

15. The method of claim 14, wherein the product body is cylindrically symmetric.

16. The method of claim 14, wherein the positioning the barcode repetitively comprises:
separating two instances of the barcode by a gap.

17. The method of claim 14, wherein the positioning the barcode repetitively comprises:
separating two instances of the barcode by a white gap having no coded bar therein.

18. The method of claim 14, wherein the positioning the barcode repetitively comprises:
separating two instances of the barcode by a black gap having no coded space therein.

19. The method of claim 14, wherein the positioning the barcode repetitively comprises:
adjoining two instances of the barcode such that there is no gap between two instances of the barcode.

20. The method of claim 14, wherein the positioning the barcode repetitively comprises:
overlapping two instances of the barcode such that the two instances of the barcode share at lest one common bar.

21. A method of reading a barcode associated with a product that has a product body with a round ending section whereon a barcode is repetitively positioned along a circle that shares a common center with an outer-ring of the round ending section, the method comprising:
positioning at least a portion of the round ending section of the product within a field of view of a barcode reader such that the field of view covers at least a portion of a first instance of the barcode and a portion of a second instance of the barcode; and
construing the barcode from the portion of the first instance of the barcode and the portion of the second instance of the barcode.

22. The method of claim 21, wherein the product body is cylindrically symmetric.
